(19) United States
(12) Patent Application Publication
(10) Pub. No.: US 2018/0285956 A1
(43) Pub. Date: Oct. 4, 2018

(54) FABRIC COMPARISON

(71) Applicant: INTERNATIONAL BUSINESS MACHINES CORPORATION, ARMONK, NY (US)

(72) Inventors: Sunil Chelani, Austin, TX (US); Malarvizhi Kandasamy, Bangalore (IN); Hansraj Mali, Pune (IN); Mohammad N. Nazmi, Dublin (IE)

(21) Appl. No.: 15/477,200

(22) Filed: Apr. 3, 2017

(51) Int. Cl. G06Q 30/06; G06Q 30/02; G06Q 50/00

(52) U.S. Cl. CPC G06Q 30/0629; G06Q 30/0631; G06F 17/602; G06Q 30/0255; G06Q 50/01; G06Q 30/0643

(57) ABSTRACT

Systems, methods and tools for providing customers of web sites, applications and online shopping programs opportunities to compare different fabrics of products with previously purchased items. Each item in the website's inventory may be assigned a fabric index score describing fabric properties such as the drapability, the GSM of fabric, capillarity, breathability, absorbance, slipperiness, thickness, softness, scratchiness, fabric content, coloration, vulnerability to discoloration, strands/gaps between threads, vulnerability to wrinkling, and suppleness. Disclosed embodiments leverage computing systems and data analytics to build an index of fabric containing products, classify parameters describing the fabric and analyzing the similarities of products viewed by customers with previously purchased products. Comparable fabrics may be viewed by the customer while browsing and selecting products, allowing the customer to more easily envision the potential fabric being purchased compared with similar fabrics already owned or in possession of the customer.

### TECHNICAL FIELD

The present disclosure relates generally to internet sales transactions and data analytics.

### BACKGROUND

The use of the global information network known as the Internet as a medium for carrying out sales transactions (i.e., online transactions) has become increasingly more common in recent years. The popularity of the Internet with home computer users and businesses has provided a market opportunity to provide transaction mechanisms for such Internet users. In a conventional online shopping system, using a personal computer based communication network or similar type of network, a merchant's web page or service may supply merchandise information in response to a merchandise search request from a user. Retailers, for example, have launched “online catalogs” via Web pages as an alternative (or additional) means for selling their products or services to their customers.

In the past, consumers were required to physically visit a location such as a store or shopping mall to purchase products. Currently, with the expanding use of the Internet and World Wide Web, there are many web pages allowing users to browse and purchase merchandise without ever leaving the computer terminal. For consumers who dislike shopping, have limited in time, live in rural areas where shopping is limited, or for some reason cannot physically visit the store, shopping online is an ideal way to purchase products.

### SUMMARY

A first embodiment of the present disclosure provides a method for comparing fabric textures comprising the steps of: loading, by a processor, a user profile including a purchase history of a user; retrieving, by the processor, a fabric index describing one or more parameters of each fabric stored by the purchase history as a fabric index score and a garment selected by the user as a fabric score; analyzing, by the processor, the fabric score of the garment compared to the fabric index score for each fabric stored by the purchase history of the user; selecting, by the processor, each fabric stored in the purchase history having a fabric index score within a selected range of the fabric score of the garment; displaying, by the processor, each fabric stored by the purchase history of the user profile having the fabric index score within the selected range of the fabric score of the garment to the user as a recommendation of a comparable fabric.

A second embodiment of the present disclosure provides a computer system comprising a processor; a memory device coupled to the processor; and a computer readable storage device coupled to the processor, wherein the storage device contains program code executable by the processor via the memory device to implement a method for comparing fabric textures comprising the steps of: loading, by the processor, a user profile including a purchase history of a user; retrieving, by the processor, a fabric index describing one or more parameters of each fabric stored by the purchase history as a fabric index score and a garment selected by the user as a fabric score; analyzing, by the processor, the fabric score of the garment compared to the fabric index score for each fabric stored by the purchase history of the user; selecting, by the processor, each fabric stored in the purchase history having a fabric index score within a selected range of the fabric score of the garment; displaying, by the processor, each fabric stored by the purchase history of the user profile having the fabric index score within the selected range of the fabric score of the garment to the user as a recommendation of a comparable fabric.

A third embodiment of the present disclosure provides a computer program product comprising: one or more computer readable hardware storage devices having computer readable program code stored therein, said program code containing instructions executable by one or more processors to implement a method for comparing fabric textures comprising the steps of: loading, by the processor, a user profile including a purchase history of a user; retrieving, by the processor, a fabric index describing one or more parameters of each fabric stored by the purchase history as a fabric index score and a garment selected by the user as a fabric score; analyzing, by the processor, the fabric score of the garment compared to the fabric index score for each fabric stored by the purchase history of the user; selecting, by the processor, each fabric stored in the purchase history having a fabric index score within a selected range of the fabric score of the garment; displaying, by the processor, each fabric stored by the purchase history of the user profile having the fabric index score within the selected range of the fabric score of the garment to the user as a recommendation of a comparable fabric.

### BRIEF DESCRIPTION OF THE DRAWINGS

FIG. 1 depicts a block diagram of an embodiment of a system for comparing fabric textures.

FIG. 2 illustrates an embodiment of client device displaying a comparison between fabric textures.

FIG. 3 depicts a flow diagram of an embodiment of an algorithm for comparing fabric textures.

FIG. 4 depicts a block diagram of a computer system able to implement the methods for comparing fabric textures, consistent with the disclosure of the present application.

### DETAILED DESCRIPTION

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

### Overview

Online shopping websites that sell fabric-based items such as clothes, carpets, furniture, curtains or any other fabric containing products, typically depict the available products using two dimensional representations of the product. For example, photographs or illustrations that depict the product to the customers. The two dimensional renderings often have multiple views, including front, back side and interior. The two dimensional renderings may enable customers to visualize or imagine how the fabric and the material of the items may generally appear. However, customers are unable to experience or feel the fabrics of the products being sold until the product is physically delivered to the customer. Currently, there does not exist a way for a customer to experience the texture of a fabric, other than by either ordering the product or receiving a physical sample of the material used to create the product (which may not always be an option).

Embodiments of the present disclosure leverage computer systems and data analytics to provide customers and users of online shopping web sites with an opportunity to analogize different fabrics using a comparison between the selected fabric-containing products and previously purchased items having substantially similar fabric characteristics. In some embodiments, a customer may access an online shopping website using a customer's client device to gain access via a web portal. The customer may log into a personalized profile or account that may track the customer's previous purchases. As items are purchased by the customer, the online shopping website's server may collect data classifying the fabric by one or more parameters from a data set or index of fabric characteristics. As the customer continues to shop on the website, each item having a fabric component, selected or viewed by the customer, may be analyzed and compared with previous fabric-based items purchased by the customer. These comparable fabrics may be presented and viewed by the customer, allowing the customer to know what to expect of the potential fabric being purchased in order to compare the viewed fabrics with similar fabrics already owned or in possession of the customer.

Embodiments of the online shopping system may present and display comparable fabrics to the customer based on the customer's previous purchases. In some embodiments, the online shopping system may receive manufacturer data from the manufacturer, a manufacturer's data server and/or rate the fabrics of each of the items for sale and build a database to index each fabric parameter measured. Each fabric-based item in the web site's inventory may be assigned a fabric index score describing properties of the fabrics, such as the drapability rating of the fabric, the grams per square meter (GSM) of fabric, capillarity of the fabric, breathability, absorbance, slipperiness, thickness, softness, coloration, softness or hardness, fabric content, expectation of discoloration after washing, air permeability, relative comfort, strand gaps between threads, loose threads, suppleness (particularly for leather products), susceptibility of wrinkling (e.g. for linens), scratchiness, etc. Based on the fabric grade, a comparison report can be generated containing details of each new garment (e.g. more/less, soft/harder than the previously purchased garments or products). By seeing the comparison report, a user can guess/feel the garment texture from the online shopping site. Using the report, the currently viewed products and previously purchased products may be directly compared. For example, by comparing whether the product being viewed is thicker or thinner (less/more, soft/hard), darker color vs lighter color, cooler vs hotter (for various climatic conditions), softer vs harder, a fabric content comparison, discoloration comparison after wash, fabric air permeability, moisture absorption, whether the fabric is breathable, comfortable (for cotton cloths), experiences loose strands or gaps between threads (for woolen cloths), soft vs supple (for leather), susceptibility to becoming wrinkled (for linen), soft vs scratchy (for denim).

As the customer continues to browse the online shopping website, the online shopping system may compare the currently viewed product's fabric score with the closest fabric scores of the closest products previously purchased. The closest products may be displayed and the similarities of the fabrics may be described in order to provide the customer with information that can inform the customer with knowledge of each fabric's similarities. Accordingly, based on the presented information, a customer may understand the feel and texture of a fabric that the customer may purchase because the properties of the fabric are substantially similar to the previously purchased products.

### System for Comparing Fabric Textures

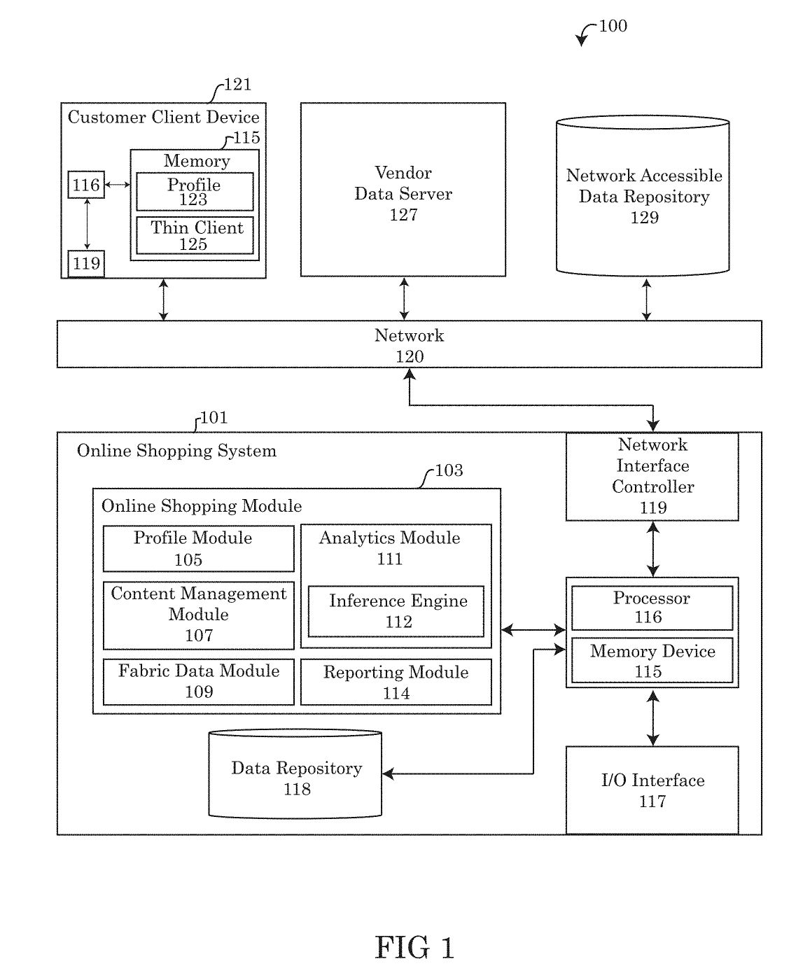

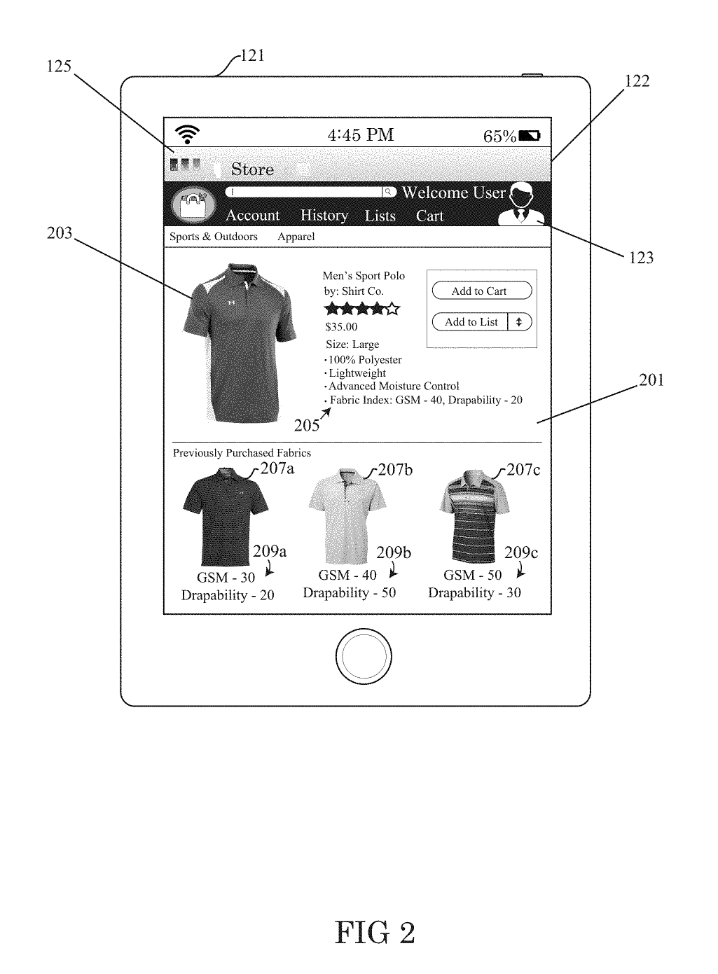

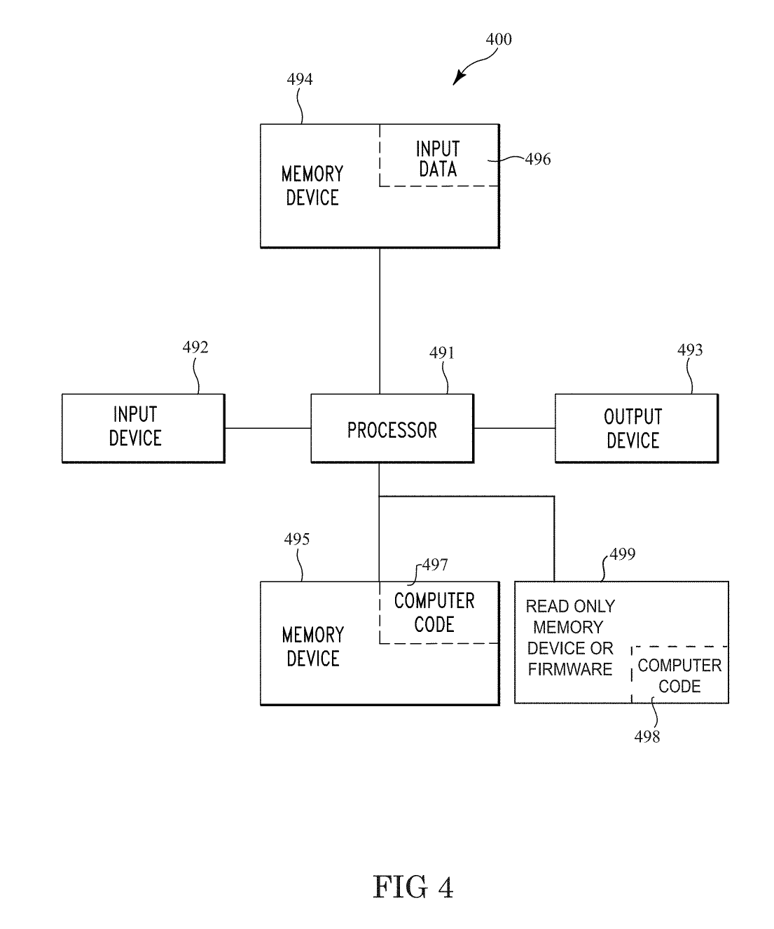

Referring to the drawings, FIG. 1 illustrates a diagram of an embodiment of a system 100 for comparing fabric textures consistent with the disclosures of this application. Embodiments of system 100 may comprise one or more specialized computer systems 101, 121, 127 having a specialized configuration of hardware, software or a combination thereof, as depicted in FIG. 1-2 and as described throughout the present disclosure. Embodiments of the computer systems 101, 121, 127 may further comprise one or more elements of the generic computer system 400 of FIG. 4, described in detail below. The elements of the generic computer system 400 may be integrated into each of the specialized computer systems 101, 121, 127 described herein.

Embodiments of each computer system 101, 121, 127 that may be present in the system 100, may be a specialized computer system 101, 121, 127 which may include a processor 116, specialized hardware or circuitry and/or software loaded into the memory device 115 of the computer system 101, 121, 127. Each embodiment of the computer systems 101, 121, 127 may perform functions, tasks and routines relating to methods for comparing fabric textures described herein, including storing, loading, updating and displaying user profiles, displaying or delivering an online shopping web page and the content forming the online shopping web page, storing and indexing fabric properties for each product provided by the online shopping webpage, analyzing the properties of two or more fabrics, drawing inferences about the analyzed fabrics' similarities and reporting the results of the similarity analysis of the different fabrics.

Embodiments of the specialized hardware and/or software may be integrated into each of the computer systems 101, 121, 127 for comparing fabric textures. As shown in FIG. 1, the online shopping system 101 may include an online shopping module 103 performing each of the functions of the online shopping system 101. The online shopping module 103 may perform the tasks or functions relating to customer profile management, content management of the online shopping web pages, indexing the fabric properties of the fabric-containing products of the online store, performing data analytics analyzing the differences between the fabric properties of viewed and previously purchased products and drawing inferences from the analysis to provide a list of recommended fabrics having similar properties to products purchased by the customer of the online shopping system 101.

In some embodiments, the hardware and/or software components of the online shopping module 103 may include one or more sub modules performing each task of the online shopping system 101. The sub modules of the online shopping module 103 may include a profile module 105, content management module 107, fabric module 109, analytics module 111 which may comprise an inference engine 112 and a reporting module 114. As used herein, the term “module” may refer to a hardware module, software-based module or a module may be a combination of hardware and software resources of the online shopping system 101 and/or resources remotely accessible to the online shopping system 101 via a computer network 120, such as a fabric manufacturer data server 127, customer client device 121 and/or a network accessible data repository 129.

Embodiments of the online shopping system 101, may, in some embodiments be connected and placed in communication with one or more additional computer systems 121, 127 or computer resources 129 via a computer network 120. These additional computer systems include one or more client devices 121, data servers 127 and data repositories 129. Embodiments of the network 120 may be constructed using wired or wireless connections between each hardware component connected to the network 120. As shown in the exemplary embodiment 100 of FIG. 1, each of the computer systems 101, 121, 127 may connect to the network 120 and communicate over the network 120 using a network interface controller (NIC) 119 or other network communication device. Embodiments of the NIC 119 may implement specialized electronic circuitry allowing for communication using a specific physical layer and a data link layer standard, such as Ethernet, Fiber channel, Wi-Fi or Token Ring. The NIC 119 may further allow for a full network protocol stack, enabling communication over network 120 to the group of computer systems or other computing hardware devices or virtual devices linked together through communication channels.

The network 120 may facilitate communication and resource sharing among the computer systems 101, 121, 127 and additional hardware, software or virtual devices connected to the network 120, for example a network accessible data repository 129 or other network accessible storage devices connected to the network 120. Examples of network 120 may include a local area network (LAN), home area network (HAN), wide area network (WAN), backbone networks (BBN), peer to peer networks (P2P), campus networks, enterprise networks, the Internet, cloud computing networks and any other network known by a person skilled in the art.

Embodiments of the modules described in this application, whether comprising hardware, software or a combination of resources thereof, may be designed to implement or execute one or more particular functions, tasks or routines of the online shopping system 101, customer client devices 121 and network accessible servers 127 described herein. Embodiments of hardware-based modules may include self-contained components such as chipsets, specialized circuitry and one or more memory devices 115 comprising a memory storage medium (described below). A software-based module may be part of program code or linked to program code or computer code 497, 498 containing specific programmed instructions loaded into the memory device 115 of the online shopping system 101, and/or a remotely accessible memory device 115 of a network accessible customer client devices 121 or vendor data servers 127. For example, in some embodiments the customer client devices 121 may connect to the online shopping system 101 through a web portal wherein the online shopping system may provide content to the customer client devices 121 by acting as a server such as web server, application server, or other content delivery system remotely over the network 120.

Embodiments of the online shopping module 103 may comprise a profile module 105, which may perform the task or function of identifying a customer accessing the online shopping system 101, authorizing access of the customer's profile 123 from the customer client device 121 and tracking the customer's behavior while accessing the online shopping system 101, including tracking the customer's purchase history and browsing history. Embodiments of the profile module 105 may include hardware components and/or software program code loaded in the memory device 115 of the online computer system 101 or the customer client device 121.

A client device 121 accessing the online shopping system 101 may make one or more permissions requests to the profile module 105 in order to access one or more customer profiles 123. Customer profiles stored by the online shopping system 101 or the network accessible data repository 129 may be authorized and loaded into the memory device 115 of the customer's client device 121. Using an established network 120 connection between the online shopping system 101 and customer client device 121, the customer client device may make a request to access the account profile information of the customer which may have been previously saved and store by the profile module 105, the last time the customer accessed the web page or application served by the online shopping system 101. In some embodiments, the customer client device 121 may gain access to the profile 123 stored by the profile module 105 using a protocol such as HTTP, TCIP, UDP, peer to peer (P2P) or other established protocol to gain access and retrieve the customer's profile 123 while accessing the online shopping system 101. In some embodiments, the profile module 105 may store login keys, security tokens, registration credentials or authorize handshaking between the online shopping system 101 and the customer's client device. Once authorized by the profile module 105, the customer accessing the online shopping system 101 may gain access to the content of the customer profile 123, including account information, access history, previously viewed or purchased products, wish lists, purchase information, billing information and shipping information.

Embodiments of the online shopping system 101 may further comprise a content management module 107. The content management module may perform the task and/or function of serving the content of the online shopping system 101 to one or more customer client devices 121 accessing a web page, application, or portal serviced by the online shopping system 101. For example, the online shopping system 101 may operate an internet shopping website or application offering for sale a plurality of different products that may be purchased by a customer. The content management module 107 may be responsible for delivering the objects and features web page or application content viewed on the customer's client device 121 and/or displayed on an interface 201 of the customer's client device 121, including images of products and previous products purchased by the customer.

FIG. 2 depicts an example of the content that may be delivered from the online shopping system 101 to the customer's client device 121 accessing the online shopping system. As shown in FIG. 2, the customer's client device may be accessing the online shopping system 101 using a thin client 125 such as a web browser in some embodiments, to display a user interface 201 on a display device 122 of the client device 121. Embodiments of the display device 122, such as a screen or monitor may display each piece of content delivered from the content management system 107 over network 120 to the customer's client device 121.

Embodiments of the content displayed on the interface 201 and loaded onto the client device 121 may be specifically tied to the customer's profile 123 and tracked by online shopping system 101 or the profile module 105 while the customer may be logged into the online shopping system 101. The online shopping system may track one or more products 203 being viewed by the customer as well as previously purchased products 207. In some embodiments, as the customer selects and changes the products being viewed 203 using the customer client device 121, a request may be made to the online shopping system 101 for the updated content corresponding to the web page or application content requested for display by the client device 121. The content management module 107 may be responsible for querying or locating the requested content and transmitting the content from the online shopping system 101 over network 120 to the client device 121 for display on display device 122 providing the interface 201.

In some embodiments of the system 100, the online shopping module 103 may comprise a fabric data module 109. Embodiments of the fabric module 109 may characterize the fabrics used or integrated into each of the products offered for sale by the online shopping system 101 and store the information in a fabric index. The fabric data module 109 may perform the task of collecting fabric data from one or more data sources and compiling the fabric data into the fabric index. The fabric index may be stored locally in a data repository 118 or the fabric index may be remotely stored and accessible via the network 120 in a network accessible data repository 129. Embodiments of the fabric index may provide a score, rating or numerical value for each of the tangible properties of the fabrics being indexed. The scores assigned to the fabrics may be standardized allowing for a direct comparisons between the fabrics compiled into the fabric index in order to determine similarities between fabrics. The fabric index may organize and format each of the properties or parameters of the fabrics offered for sale by the online shopping system 101 into a more easily queried data structure of the fabric index, in turn allowing for the data structure containing the characterized fabrics to be more easily searched and retrieved as requested by the online shopping system 101 or the customer client device 121.

In some embodiments, the owner, user, employee, developer or administrator of the online shopping web site or application being serviced by the online shopping system 101, may individually enter one or more properties of each available fabric-containing products into the fabric index manually. The fabric data being inputted into the fabric index may be received and updated by the fabric data module 107 as a function of the input provided by the owner, user developer, administrator, etc. operating the online shopping web site or application. Embodiments of the fabric data describing the properties of each fabric-containing product offered by the online shopping system 101 may include, but are not limited to such properties as the texture grade of the fabric, drapability rating, grams per square meter (GSM) of the fabric which may indicate softness, the thickness of the fabrics, slipperiness, friction co-efficient, capillarity, absorbability, breathability, coloration, hardness, elasticity, fabric content, expectation of discoloration after washing, air permeability, relative comfort, strand gaps between threads, loose threads, suppleness (particularly for leather products), susceptibility of wrinkling (e.g. for linens), scratchiness and any other property that may describe one or more features of the fabric's physical properties including the feel of behavior of the fabric. As the fabric data is input into the online shopping system 101, the inputted data may be organized and formatted by the fabric module 109 into a searchable data set, table or other type of data structure.

In some embodiments of the online shopping system 101, the fabric data module 109 may retrieve fabric data from one or more manufacturers or vendors of the products being offered for sale by the online shopping system 101. Manufacturers of products may transmit fabric data to the online shopping system 101 for the purposes of indexing the properties of each fabric in the fabric index maintained by the fabric module 109. The manufacturers or vendors of products may periodically connect the online shopping system 101 and maintain or update the fabric scores of the available products indexed by the fabric index and add new products to the fabric index as well. In some embodiments, the manufacturer or vendor may upload a table, list or other data structure to the fabric data module 109. Upon receipt of the uploaded fabric data, the fabric data module may parse the fabric data and consolidate the fabric data into the fabric index.

In some alternative embodiments, instead of relying on vendors and manufacturers to supply fabric data for each product, the online shopping system may retrieve or download the fabric data directly from the vendors and manufacturers. For instance, in some embodiments, the online shopping system 101 may connect over the network 120 to each vendor or manufacturer data server 127 maintaining the fabric data of the products available for sale by the online shopping system 101. Upon connecting to one or more data servers 127, the fabric module 109 may download the fabric data from the data server 127 and store the fabric data in the memory device 115 of the online shopping system 101, an onboard memory device of the fabric data module 109, a data repository 118 or network accessible data repository 129. Alternatively, in yet another embodiment of the online shopping system 101, the manufacturer or vendor may publish a list of fabric data for fabric-based products carried by the online shopping system 101. The fabric module 109 may parse the manufacturer or vendor operated publications, such as the vendor's websites and applications for the fabric data relevant to the online shopping system's products offered for sale. The data parsed from the manufacturer, vendor publications or other data sources may written to the fabric index or periodically updated by the online shopping system 101.

In some embodiments, the fabric data module 109 may work together with the profile module 105 to identify and classify the properties of products containing one or more fabrics-based items that may have been previously purchased by the customer accessing the online shopping system 101. Embodiments of the fabric module 109 may query a customer's profile 123 maintained by the profile module 105. More specifically, embodiments of the fabric data module may query a list of purchased products maintained by the profile module 105 for products that may contain fabrics. The fabric module 109 may identify from the query of the profile 123, each fabric containing product purchased by the customer, the product name, manufacturer or vendor and any associated fabric scores that may describe the properties of the fabrics. The fabric data module may compare the list of previously purchased fabric products with the fabric index and identify the fabric scores of the previously purchased products, if said previously purchased products have been indexed.

In some embodiments, the identified fabric products associated with previously purchased products may not include entries in the fabric index. The fabric data module may subsequently identify the products missing from the fabric index, retrieve fabric data associated with the product and add each missing product to the fabric index as well as any missing parameters that may be retrieved from manufacturer or vendor of the product or the appropriate data server 127.

In some embodiments, the owners or employees of the website or application being served by the online shopping system 101 may input the fabric data using a scanning device. The owners or employees of the website or application may input fabric data that may be encoded on a bar code attached to a product being sold by the online shopping system 101. While inputting inventory to the online shopping system 101, the owner or employee of the online shopping system may scan the bar code encoding fabric data. Upon scanning the bar code, the encoded data may be read by the scanning device. The fabric data may be transmitted or uploaded by the scanning device to the online shopping system 101 in some embodiments. Alternatively, in some embodiments, customers accessing the online shopping system 101 may input fabric data into the customer's profile of previously purchased products by using a scanning device to scan a product's bar code encoding the fabric data upon receiving a purchased product. For example, the customer may use the customer's client device 121 to scan the bar code, for instance by using an onboard camera. The data from the scanned bar code may be stored in the memory device 115 of the customer's client device, an application linked to the online shopping system 101, the customer's profile 123 or uploaded to a network accessible data repository 129. The fabric data provided from the bar code may be transmitted to the fabric data module 109 or periodically retrieved by the fabric data module 109 in some embodiments.

In some embodiments of the online shopping system 101, the online shopping module 103 may further include an analytics module 111. The analytics module 111 may perform the act of comparing the fabrics of products 203 selected by the customer for purchase with the fabrics of previously purchased products 207a, 207b, 207c (referred to hereinafter as “previously purchased products 207”). The comparison of selected products 203 and previously purchased products may be performed using the fabric index containing fabric scores for the indexed products, which may include both previously purchased products 207 and the currently selected product 203. Using the fabric data collected by the fabric index, embodiments of the analysis module 111 may analyze the previously purchased products 207 for fabrics comprising properties that are most closely related to the selected product 203. In particular, the analytics module 111 may compare the fabric index scores of the selected product 203 with each of the scores associated with fabrics previously purchased 207 previously purchased 207. The scores for the fabric data may be organized and sorted by the analytics module into data sets having the closest fabric index scores or one or more particular properties within a determined threshold. The analysis module 111 may present previously purchased products 207 to the customer in order for the customer to visualize, analogize and imagine the similarities between fabric properties of the currently selected product 203, giving the customer a better understanding of the product the customer may be considering for purchase.

In some embodiments, the analytics module 111 may draw one or more inferences about the fabrics and fabric data describing the previously purchased products 207 and the currently selected product 203. Embodiments of the inference engine 112, may provide logical conclusions about similarities of the products 203, 207 and even rate the previously purchased fabric products 207 by the properties closest to the properties of the selected product 203 as a function of the analytics module's 111 comparisons. The inference engine 112 may contain a knowledge base of facts and rules which may allow for the inference engine 112 to apply logic to the analysis performed by the analysis engine 111 and ultimately provide conclusions based on the knowledge, rules and facts to direct the customer's product selection and give an impression of the texture and feel of the selected product 203 without the product 203 having to be physically experienced by the customer.

FIG. 2 provides an example of an interface 201 of an online shopping website served by the online shopping system 101. The embodiments of the interface 201 may be displayed on the display device 122 of the customer's client device 121. As shown by the example in FIG. 2, the customer may select to view one or more selected products 203. In this particular instance, a men's polo shirt. The interface 201 displaying the selected product 203 may, in some embodiments display one or more parameters of the selected product on the interface 201 for the customer to view. In this exemplary embodiments, the interface 201 is displaying a fabric index score 205 for the GSM of the selected product 203 having a rating of 40 g/m² of the fabric and a drapability rating of 20. Based on the index scores characterizing the properties of the selected product 203 shown in FIG. 2, the analytics module 111 may query the fabric index for other fabric-containing products that may have been previously purchased 207 by the customer. The analytics module 111 may compare previously purchased products 209 with the selected product 203 and identify each previously purchased products 207 having similar fabric scores 209a, 209b, 209c (referred to collectively as “fabric score 209”) on the fabric index or a fabric score within a pre-determined threshold of the selected product 203.

Embodiments of the analytics module 111 and the inference engine 112 may draw conclusions about the closest fabrics of previously purchased products 207 to the selected product 203. Once the closest previously purchased products have been concluded by the analytics module 111 and/or the inference engine 112, the online shopping system 101 may transmit and display the content of the previously purchased products 207 to the customer's client device 121. As shown in exemplary embodiment of FIG. 2, the content being displayed for the closest previously purchased products 207 may be presented on the interface 201 as the customer shops on the shopping website or application. The most applicable, previously purchased products 207, may be presented to the customer so the customer may use the information as a reference to determine how close the currently selected product 203 is to the previously purchased products. In some embodiments, the index scores 209 of the previously purchased products may be displayed on the interface 201 as well, further providing fabric data the customer may use for making the comparison of between the fabrics.

In some embodiments, the analytics module 111 and the inference engine 112 may select previously purchased products 207 having a fabric score 209 within a pre-set, preprogrammed or pre-determined margin of difference between the fabric index scores 205, 209. In some embodiments, a single fabric score 205, 209 within an acceptable range may be considered close enough to display the similar fabric to the customer on the customer's display device 121. Alternatively, in some embodiments, similar fabrics may have multiple properties within the acceptable fabric score range. The inference engine 112 may organize the previously purchased products 207 by the similarities of the fabrics with an overall closest score to the selected product 203 in a plurality of properties and present the closest fabrics first, while the other previously purchased products 207 that may have a similar fabric index score (but not as close as other similar fabrics), may be presented as fabric score 209 later or after the next closest fabrics.

For example, the previously purchased fabrics 207 may be ordered and presented by the fabric considered to be the closest match to the selected fabric 203. In such an embodiment, the inference engine 112 may have determined that the closest fabric to product 203 is the previously purchased product 207a having a fabric score 209a with a GSM of 30 and a drapability of 20. The next closest, previously purchased product 207b, may be presented next, having a fabric score 209b with a GSM of 40 and a drapability rating of 50. Likewise the inference engine 112 may have identified previously purchased product 207c as being an acceptable comparison to the selected product 203. However, the properties of the previously purchased product 207c may not be nearly as close to the fabric scores of the selected product 203 as the previously purchased products 207a or 207b. The inference engine 112 may conclude, that that while the previously purchased product 207c is an acceptable fabric to compare with the selected product 203, the previously purchased product 207c may be merely the third best comparison due to having a fabric score 209c with a GSM of 50 and a drapability of 30.

Embodiments of the reporting module 114 may be responsible for reporting and displaying output from the online shopping system 101 in a readable format that a customer may understand. For example, the reporting module 114 may be responsible for presenting information and data generated or transmitted by the online shopping system 101 to the customer client device 121. The reporting module 114 may transmit web page or application content authorized by the content management module 107 such as product information, fabric scores from the fabric module 109, analytical conclusions of the analytics modules 111, previously present purchased products 207 having fabric scores 209 comparatively similar to products currently being viewed or selected by the customer using the customer's client device 121.

### Method for Comparing Fabric Textures

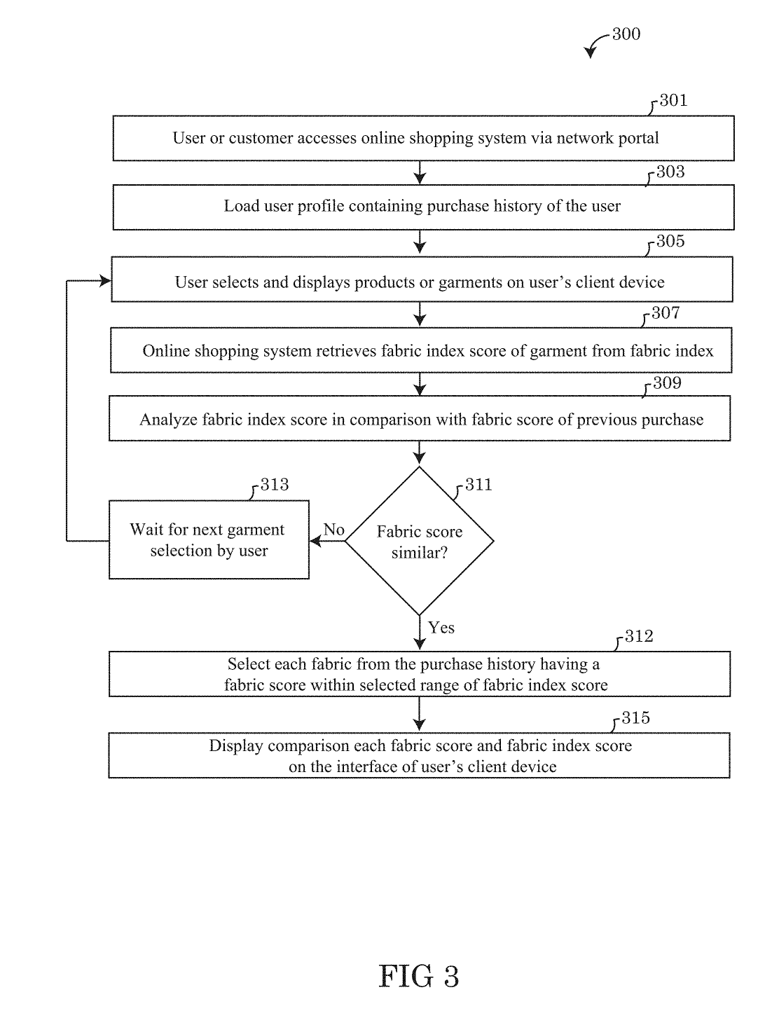

The drawing of FIG. 3 represents an embodiment 300 of an algorithm that may be implemented for comparing fabric textures, in accordance with the systems described in FIGS. 1-2 using one or more computer systems defined generically in FIG. 4 below, and more specifically by the specific embodiments depicted in FIGS. 1-2. A person skilled in the art should recognize that the steps of the method described in FIG. 3 may not require all of the steps disclosed herein to be performed, nor does the algorithm of FIG. 3 necessarily require that all the steps be performed in the particular order presented. Variations of the method steps presented in FIG. 3 may be performed in a different order than presented by FIG. 3.

The algorithm 300, described in FIG. 3, may initiate in step 301 by a user or customer accessing the online shopping system 101 over the network 120 via a network accessible portal. The customer or user may access the online shopping system from a computing device such as a customer client device 121 or any other type of computing device including a desktop PC, laptop, tablet computer, smartphone, cell phone, network enabled media device, etc. Upon accessing the online shopping system 301, the user or customer may, in step 303, load a user profile 123 from the profile module 105 into the memory device 115 of the user's client device 121. The user's profile 123 may comprise the purchase history of the user or customer while accessing the online shopping system 101.

In some embodiments of the algorithm 300, the user or customer accessing the online shopping system may, in step 305, select products 203 such as garments or other fabric-containing products by browsing the web pages or interface 201 presented on the customer's client device 121. The displayed interface 201 presenting the products may be delivered from the content management module 107 to the client device 121, whereby the customer may browse and view available products for purchase. The selected products 203 may be displayed on the display device 122 of the customer's client device 121.

In step 307 of the algorithm, the online shopping system may retrieve the fabric index score of the selected product 203, selected for viewing as a potential purchase by the customer in step 305. The fabric index scores may be previously retrieved or stored by the online shopping system in one or more computer storage devices. In alternative embodiments, the online shopping system 101 may retrieve fabric index scores of the selected products 203 from a vendor or manufacturer's web site, published material, data server 127 or application server. In step 309, the analytics module 111 may compare the fabric index score of the selected product 203 with each fabric score of the previously purchased products 207 currently on file in the customer's profile 123 being maintained by the profile module 105. Embodiments of the analytics module 111 may query a fabric module 109 responsible for maintaining a fabric index of each product available for sale by the online shopping system 101, including previously purchased products 207.

In step 311, the analytics module 111 and/or the inference engine 112 of the analytics module may draw one or more conclusions about the similarities between the selected product 203 and the previously purchased products 207. In the exemplary embodiment, the comparison of similarities between the fabrics may be a comparison of each property of the fabrics quantified by the fabric index. Fabrics having properties with numerical scores closer to one another may be considered similar for that particular property. The overall number of properties having similar index scores may indicate the overall similarity to the look, feel, texture and behavior of the fabrics being compared by the analytics module 111. If, in step 311, a conclusion is drawn by the analytics module 111 or the inference engine 112 that the selected product 203 and one or more previously purchased products 207 are not similar to one another (i.e. the compared fabric scores are not within an acceptable range), the reporting module 114 of the online shopping system may not display to the customer's client device 121 a previously purchased product 207 that may have a similar fabric texture. Instead, the online shopping system 101 may proceed to step 313 and wait for the next product or garment to be selected by the user or customer operating the customer client device 121.

Conversely, if, in step 311, a fabric score of one or more previously purchased products having one or more properties classified in the fabric index, is within an acceptable range of the selected product 207, the algorithm 300 may proceed to step 312. In step 312, the online shopping system 101 may select each previously purchased product 207 having a fabric score within the acceptable range of the fabric index score of the selected product 203 and in step 315, transmit the product data to the customer client device 121, displaying a comparison between the selected product 203 having one or more displayed properties of the fabric comprising the selected product and/or a particular fabric score of the properties similar to the previously purchased products 207 and the previously purchased products including the fabric score of said products.

### Computer System

Referring to the drawings, FIG. 4 illustrates a block diagram of a computer system 400 that may be included in the systems of FIGS. 1-2 and for implementing the methods for comparing fabric textures of FIG. 3 and in accordance with the embodiments described in the present disclosure. The computer system 400 may generally comprise a processor 491, otherwise referred to as a central processing unit (CPU), an input device 492 coupled to the processor 491, an output device 493 coupled to the processor 491, and memory devices 494 and 495 each coupled to the processor 491. The input device 492, output device 493 and memory devices 494, 495 may each be coupled to the processor 491 via a bus. Processor 491 may perform computations and control the functions of computer 400, including executing instructions included in the computer code 497 for tools and programs for comparing fabric textures, in the manner prescribed by the embodiments of the disclosure using the systems of FIGS. 1-2 wherein the instructions of the computer code 497 may be executed by processor 491 via memory device 495. The computer code 497 may include software or program instructions that may implement one or more algorithms for implementing the methods for comparing fabric textures, as described in detail above and in FIG. 3. The processor 491 executes the computer code 497. Processor 491 may include a single processing unit, or may be distributed across one or more processing units in one or more locations (e.g., on a client and server).

The memory device 494 may include input data 496. The input data 496 includes any inputs required by the computer code 497, 498. The output device 493 displays output from the computer code 497, 498. Either or both memory devices 494 and 495 may be used as a computer usable storage medium (or program storage device) having a computer readable program embodied therein and/or having other data stored therein, wherein the computer readable program comprises the computer code 497, 498. Generally, a computer program product (or, alternatively, an article of manufacture) of the computer system 400 may comprise said computer usable storage medium (or said program storage device).

Memory devices 494, 495 include any known computer readable storage medium, including those described in detail below. In one embodiment, cache memory elements of memory devices 494, 495 may provide temporary storage of at least some program code (e.g., computer code 497, 498) in order to reduce the number of times code must be retrieved from bulk storage while instructions of the computer code 497, 498 are executed. Moreover, similar to processor 491, memory devices 494, 495 may reside at a single physical location, including one or more types of data storage, or be distributed across a plurality of physical systems in various forms. Further, memory devices 494, 495 can include data distributed across, for example, a local area network (LAN) or a wide area network (WAN). Further, memory devices 494, 495 may include an operating system (not shown) and may include other systems not shown in the figures.

In some embodiments, rather than being stored and accessed from a hard drive, optical disc or other writeable, rewriteable, or removable hardware memory device 494, 495, stored computer program code 498 (e.g., including algorithms) may be stored on a static, non-removable, read-only storage medium such as a Read-Only Memory (ROM) device 499, or may be accessed by processor 491 directly from such a static, non-removable, read-only medium 499. Similarly, in some embodiments, stored computer program code 497 may be stored as computer-readable firmware 499, or may be accessed by processor 491 directly from such firmware 499, rather than from a more dynamic or removable hardware data-storage device 495, such as a hard drive or optical disc.

In some embodiments, the computer system 400 may further be coupled to an Input/output (I/O) interface and a computer data storage unit (for example a data store, data mart or repository). An I/O interface may include any system for exchanging information to or from an input device 492 or output device 493. The input device 492 may be, inter alia, a keyboard, joystick, trackball, touchpad, scanning device, bar code reader, mouse, sensors, beacons, RFID tags, microphones, biometric input device, camera, timer, etc. The output device 493 may be, inter alia, a printer, a plotter, a display device (such as a computer screen or monitor), a magnetic tape, a removable hard disk, a floppy disk, etc. The memory devices 494 and 495 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 400, and may include any type of transmission link, including electrical, optical, wireless, etc.

The I/O interface may allow computer system 400 to store information (e.g., data or program instructions such as program code 497, 498) on and retrieve the information from a computer data storage unit (not shown). Computer data storage units include any known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk).

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider able to deploy or integrate computing infrastructure with respect identifying errors in a multi-threaded application. Thus, an embodiment of the present invention discloses a process for supporting computer infrastructure, where the process includes providing at least one support service for at least one of integrating, hosting, maintaining and deploying computer-readable code (e.g., program code 497, 498) in a computer system (e.g., computer 400) including one or more processor(s) 491, wherein the processor(s) carry out instructions contained in the computer code 497 causing the computer system to identify errors in an application. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for comparing fabric textures as described in this application. Thus the present invention discloses a process for supporting, deploying and/or integrating computer infrastructure, integrating, hosting, maintaining, and deploying computer-readable code into the computer system 400, wherein the code in combination with the computer system 400 is capable of performing a method of comparing fabric textures.

A computer program product of the present invention comprises one or more computer readable hardware storage devices having computer readable program code stored therein, said program code containing instructions executable by one or more processors of a computer system to implement the methods of the present invention.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method for comparing fabric textures comprising the steps of:
loading, by a processor, a user profile including a purchase history of a user;
retrieving, by the processor, a fabric index describing one or more parameters of each fabric stored by the purchase history as a fabric index score and a garment selected by the user as a fabric score;
analyzing, by the processor, the fabric score of the garment compared to the fabric index score for each fabric stored by the purchase history of the user;
selecting, by the processor, each fabric stored in the purchase history having a fabric index score within a selected range of the fabric score of the garment;
displaying, by the processor, each fabric stored by the purchase history of the user profile having the fabric index score within the selected range of the fabric score of the garment to the user as a recommendation of a comparable fabric.

2. The method of claim 1, wherein the fabric score and fabric index score include a fabric drapability rating.

3. The method of claim 1, wherein the fabric score and the fabric index score include a measurement of grams per square meter (GSM) of fabric.

4. The method of claim 1, where the fabric index is generated by the steps comprising:
connecting, by the processor, to a fabric manufacturer server via a network connection;
requesting, by the processor, fabric index scores from the fabric manufacturer server, for each fabric stored by the purchase history of the user manufactured by a fabric manufacturer owning fabric data stored by the fabric manufacturer server; and
updating, by the processor, the fabric index scores with the fabric data retrieved from the fabric manufacturer server.

5. The method of claim 1, wherein the processor is a hardware component of a web server delivering content of an online shopping website to the user.

6. The method of claim 5, wherein the step of displaying is performed by a client device of the user accessing the online shopping website.

7. The method of claim 5, further comprising the steps of:
encoding the fabric index score into a bar code for each garment sold by the online shopping website;
scanning, by a scanning device, the bar code; and
storing, the fabric index score encoded by the bar code into the fabric index maintained by the web server.

8. The method of claim 1, further comprising providing at least one support service for at least one of creating, integrating, hosting, maintaining, and deploying computer-readable program code in a computer system, where the computer-readable program code in combination with the computer system is configured to implement the steps of loading, retrieving, analyzing, selecting and displaying.

9. A computer system, comprising:
a processor;
a memory device coupled to the processor; and
a computer readable storage device coupled to the processor, wherein the storage device contains program code executable by the processor via the memory device to implement a method for comparing fabric textures comprising the steps of:
loading, by the processor, a user profile including a purchase history of a user;
retrieving, by the processor, a fabric index describing one or more parameters of each fabric stored by the purchase history as a fabric index score and a garment selected by the user as a fabric score;
analyzing, by the processor, the fabric score of the garment compared to the fabric index score for each fabric stored by the purchase history of the user;
selecting, by the processor, each fabric stored in the purchase history having a fabric index score within a selected range of the fabric score of the garment;
displaying, by the processor, each fabric stored by the purchase history of the user profile having the fabric index score within the selected range of the fabric score of the garment to the user as a recommendation of a comparable fabric.

10. The computer system of claim 9, wherein the fabric score and fabric index score include a parameter selected from the group consisting of a fabric drapability rating, a measurement of grams per square meter (GSM) of fabric and a combination thereof.

11. The computer system of claim 9, where the fabric index is generated by the steps comprising:
connecting, by the processor, to a fabric manufacturer server via a network connection;
requesting, by the processor, fabric index scores from the fabric manufacturer server, for each fabric stored in the purchase history of the user manufactured by a fabric manufacturer owning fabric data stored by the fabric manufacturer server; and
updating, by the processor, the fabric index scores with the fabric data retrieved from the fabric manufacturer server.

12. The computer system of claim 9, wherein the processor is a hardware component of a web server delivering content of an online shopping website to the user.

13. The computer system of claim 12, wherein the step of displaying is performed by a client device of the user accessing the online shopping website.

14. The computer system of claim 12, further comprising the steps of:
encoding the fabric index score into a bar code for each garment sold by the online shopping website;
scanning, by a scanning device, the bar code; and
storing, the fabric index score encoded by the bar code into the fabric index maintained by the web server.

15. A computer program product comprising:
one or more computer readable hardware storage devices having computer readable program code stored therein, said program code containing instructions executable by one or more processors to implement a method for comparing fabric textures comprising the steps of:
loading, by the processor, a user profile including a purchase history of a user;
retrieving, by the processor, a fabric index describing one or more parameters of each fabric stored by the purchase history as a fabric index score and a garment selected by the user as a fabric score;
analyzing, by the processor, the fabric score of the garment compared to the fabric index score for each fabric stored by the purchase history of the user;
selecting, by the processor, each fabric stored in the purchase history having a fabric index score within a selected range of the fabric score of the garment;
displaying, by the processor, each fabric stored by the purchase history of the user profile having the fabric index score within the selected range of the fabric score of the garment to the user as a recommendation of a comparable fabric.

16. The computer program product of claim 15, wherein the fabric score and fabric index score include a parameter selected from the group consisting of a fabric drapability rating, a measurement of grams per square meter (GSM) of fabric and a combination thereof.

17. The computer program product of claim 15, where the fabric index is generated by the steps comprising:
connecting, by the processor, to a fabric manufacturer server via a network connection;
requesting, by the processor, fabric index scores from the fabric manufacturer server, for each fabric stored in the purchase history of the user manufactured by a fabric manufacturer owning fabric data stored by the fabric manufacturer server; and
updating, by the processor, the fabric index scores with the fabric data retrieved from the fabric manufacturer server.

18. The computer program product of claim 15, wherein the processor is a hardware component of a web server delivering content of an online shopping website to the user.

19. The computer program product of claim 18, wherein the step of displaying is performed by a client device of the user accessing the online shopping website.

20. The computer program product of claim 18, further comprising the steps of:
encoding the fabric index score into a bar code for each garment sold by the online shopping website;
scanning, by a scanning device, the bar code; and
storing, the fabric index score encoded by the bar code into the fabric index maintained by the web server.
